(19) United States
(12) Patent Application Publication
(10) Pub. No.: US 2026/0056324 A1
(43) Pub. Date: Feb. 26, 2026

(54) DAPPLED ILLUMINATION FOR DEPTH SENSORS

(71) Applicant: GM Cruise Holdings, LLC, San Francisco, CA (US)

(72) Inventors: Mohit Gupta, Madison, WI (US); Jan Olof Anttoni Jaakkola, San Jose, CA (US)

(73) Assignee: GM Cruise Holdings, LLC, San Francisco, CA (US)

(21) Appl. No.: 19/270,634

(22) Filed: Jul. 16, 2025

Related U.S. Application Data
(60) Provisional application No. 63/687,122, filed on Aug. 26, 2024.

(51) Int. Cl. G01S 17/931; B60W 10/18; B60W 10/20; B60W 30/09; G01S 7/481; G01S 17/08

(52) U.S. Cl. CPC G01S 17/931; B60W 10/18; B60W 10/20; B60W 30/09; G01S 7/4814; G01S 17/08; B60W 2420/408; B60W 2554/80; B60W 2710/18; B60W 2710/20; B60W 2720/106

(57) ABSTRACT

A method includes projecting a first illumination pattern towards a scene. The first illumination pattern illuminates a first subset of a field of view. The method includes capturing a first measurement corresponding to light reflected from the scene in response to the first illumination pattern. The method includes projecting a second illumination pattern toward the scene. The second illumination pattern illuminates the second subset of the field of view. The method includes capturing a second measurement corresponding to light reflected from the scene in response to the second illumination pattern. The method includes comparing the first measurement with the second measurement and determining a depth value for an object within the scene based on comparing the first measurement with the second measurement. The method includes controlling movement of a vehicle based on the depth value for the object.

### CROSS-REFERENCE TO RELATED APPLICATIONS

This application claims priority under 35 § 119(e) to U.S. Provisional Application Ser. No. 63/687,122, filed on Aug. 26, 2024. The disclosure of this prior application is considered part of the disclosure of this application and is hereby incorporated by reference in its entirety.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to depth sensing systems, and more specifically, to light detection and ranging (LiDAR) and other time-of-flight (ToF) systems used in vehicles. ToF systems determine distances to objects in a scene by illuminating the scene with a light source and detecting the reflected light with a sensor. The time elapsed for the light to travel from the source, reflect off an object, and return to the sensor corresponds to the distance of the object. This process may be used to generate a point cloud or depth map of the scene. Some systems, known as direct ToF (dToF), emit short pulses of light and measure their round-trip travel time directly. Other systems, known as indirect ToF (iToF), emit a continuous, temporally modulated wave of light and determine distance by measuring the phase shift between the emitted light and the received light. The illumination may be projected over an entire field of view at once or may be scanned across the scene, for instance, one column at a time.

### SUMMARY

One aspect of the disclosure provides a computer-implemented method executed on data processing hardware that causes the data processing hardware to perform operations. The operations include projecting, from a light detection and ranging (LiDAR) sensor, a first illumination pattern toward a scene. The first illumination pattern illuminates a first subset of a field of view and refrains from illuminating a second subset of the field of view. The operations include capturing, by a plurality of sensor pixels of the LiDAR sensor, a first measurement corresponding to light reflected from the scene in response to the first illumination pattern. The operations include projecting, from the LiDAR sensor, a second illumination pattern toward the scene. The second illumination pattern illuminates the second subset of the field of view and refrains from illuminating the first subset of the field of view. The operations include capturing, by the plurality of sensor pixels of the LiDAR sensor, a second measurement corresponding to light reflected from the scene in response to the second illumination pattern. The operations include comparing the first measurement with the second measurement. The operations include determining a depth value for an object within the scene based on comparing the first measurement with the second measurement. The operations include controlling movement of a vehicle based on the depth value for the object.

Implementations of the disclosure may include one or more of the following optional features. In some implementations, comparing the first measurement with the second measurement includes determining a difference between the first measurement and the second measurement on a per-pixel basis to isolate a direct light component from a spurious light component. In these implementations, determining the difference between the first measurement and the second measurement may include subtracting the second measurement from the first measurement. Here, the first illumination pattern may include a first checkerboard pattern of illumination and the second illumination pattern includes a second checkerboard pattern of illumination different than the first checkerboard pattern. In some examples, the first checkerboard pattern illuminates a first set of pixels, the second checkerboard pattern illuminates a second set of pixels, the second set of pixels are not illuminated by the first checkerboard pattern, and the first set of pixels are not illuminated by the second checkerboard pattern.

The operations may further include performing a calibration of the LiDAR sensor to account for imperfect spatial modulation of the first illumination pattern or the second illumination pattern. In some implementations, the first illumination pattern and the second illumination pattern each include square wave spatial modulations. The first illumination pattern and the second illumination pattern may each include sinusoidal spatial modulations. In some examples, the LiDAR sensor includes a direct time-of-flight sensor. The LiDAR sensor may include an indirect time-of-flight sensor.

Another aspect of the disclosure provides a vehicle that includes a light detector and ranging (LiDAR) sensor, data processing hardware, and memory hardware in communication with the data processing hardware. The memory hardware stores instructions that when executed on the data processing hardware cause the data processing hardware to perform operations. The operations include projecting, from the LiDAR sensor, a first illumination pattern toward a scene. The first illumination pattern illuminates a first subset of a field of view and refrains from illuminating a second subset of the field of view. The operations include capturing, by a plurality of sensor pixels of the LiDAR sensor, a first measurement corresponding to light reflected from the scene in response to the first illumination pattern. The operations include projecting, from the LiDAR sensor, a second illumination pattern toward the scene. The second illumination pattern illuminates the second subset of the field of view and refrains from illuminating the first subset of the field of view. The operations include capturing, by the plurality of sensor pixels of the LiDAR sensor, a second measurement corresponding to light reflected from the scene in response to the second illumination pattern. The operations include comparing the first measurement with the second measurement. The operations include determining a depth value for an object within the scene based on comparing the first measurement with the second measurement. The operations include controlling movement of the vehicle based on the depth value for the object.

Implementations of the disclosure may include one or more of the following optional features. In some implementations, comparing the first measurement with the second measurement includes determining a difference between the first measurement and the second measurement on a per-pixel basis to isolate a direct light component from a spurious light component. In these implementations, determining the difference between the first measurement and the second measurement may include subtracting the second measurement from the first measurement. Here, the first illumination pattern may include a first checkerboard pattern of illumination and the second illumination pattern includes a second checkerboard pattern of illumination different than the first checkerboard pattern. In some examples, the first checkerboard pattern illuminates a first set of pixels, the second checkerboard pattern illuminates a second set of pixels, the second set of pixels are not illuminated by the first checkerboard pattern, and the first set of pixels are not illuminated by the second checkerboard pattern.

The operations may further include performing a calibration of the LiDAR sensor to account for imperfect spatial modulation of the first illumination pattern or the second illumination pattern. In some implementations, the first illumination pattern and the second illumination pattern each include square wave spatial modulations. The first illumination pattern and the second illumination pattern may each include sinusoidal spatial modulations. In some examples, the LiDAR sensor includes a direct time-of-flight sensor.

Another aspect of the disclosure provides a computer program product encoded on a non-transitory computer readable storage medium that includes instructions that when executed by a data processing apparatus cause the data processing apparatus to perform operations. The operations include projecting, from a light detection and ranging (LiDAR) sensor, a first illumination pattern toward a scene. The first illumination pattern illuminates a first subset of a field of view and refrains from illuminating a second subset of the field of view. The operations include capturing, by a plurality of sensor pixels of the LiDAR sensor, a first measurement corresponding to light reflected from the scene in response to the first illumination pattern. The operations include projecting, from the LiDAR sensor, a second illumination pattern toward the scene. The second illumination pattern illuminates the second subset of the field of view and refrains from illuminating the first subset of the field of view. The operations include capturing, by the plurality of sensor pixels of the LiDAR sensor, a second measurement corresponding to light reflected from the scene in response to the second illumination pattern. The operations include comparing the first measurement with the second measurement. The operations include determining a depth value for an object within the scene based on comparing the first measurement with the second measurement. The operations include controlling movement of a vehicle based on the depth value for the object.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of a vehicle executing a depth model to perform dappled illumination.

FIG. 2 is a schematic view of the depth model projecting a first illumination pattern.

FIG. 3 is a schematic view of the depth model projecting a second illumination pattern.

FIG. 4 is a flowchart of an exemplary arrangement of operations for a computer-implemented method of performing dappled illumination.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Time-of-flight (ToF) depth sensors, including light detection and ranging (LiDAR) sensors, are used to generate three-dimensional representations of a surrounding environment, often for use in autonomous vehicle navigation. The fundamental operating principle of these systems relies on a set of assumptions about how light travels from a source, reflects off the scene, and returns to a sensor. In an ideal scenario, each pixel on the sensor array receives light exclusively from a single corresponding point in the scene that is directly viewing. Based on this assumption, the time delay of the received light pulse is used to calculate the distance to that single scene point.

In practice, however, this one-to-one correspondence between a sensor pixel and a scena point is frequently violated. Pixels often receive light from multiple paths, leading to erroneous depth measurements. One significant source of error is internal multipath interference, often referred to as blooming. This may occur when the scene includes highly reflective objects, such as retroreflective overhead road signs. Light returning from these objects is extremely bright. When the bright light enters the sensor, the light may bounce between the optics of the sensor and the sensor array itself before being absorbed. As a result, a portion of the light lands on pixels that are observing other, more distant parts of the scene.

A pixel affected by blooming may therefore record multiple light returns. Namely, a valid return from a corresponding scene point and a spurious return from the blooming artifact. The spurious return may be stronger and arrive earlier than the valid return, confusing the depth estimation algorithm. This can cause the system to perceive “phantom” or “ghost” objects that are not actually present, such as a vertical curtain of points appearing in the middle of a road. For a vehicle relying on this data, such an artifact may be misinterpreted as an obstacle, potentially leading to an unnecessary hard brake.

Similar depth errors may arise from other sources of indirect light. External multipath occurs when light from the source bounces between multiple objects within the scene before arriving at the sensor, resulting in an overestimation of the true depth of the object. Furthermore, adverse weather conditions such as fog or smoke can cause significant light scattering. This scattering creates an “infinite continuum of light paths” where some scattered light returns to the sensor earlier than the direct reflection from an object, leading to an underestimation of depth and a low signal-to-noise ratio. These various sources of spurious light degrade the accuracy and reliability of the data generated by depth sensors.

Accordingly, implementations herein are directed towards a depth model that projects a first illumination pattern toward a scene from a LiDAR sensor and projects a second illumination pattern towards the scene from the LiDAR sensor. The depth model may capture, by a plurality of sensor pixels of the LiDAR sensor, a first measurement corresponding to light reflected from the scene in response to the first illumination pattern and a second measurement corresponding to light reflected from the scene in response to the second illumination pattern. Moreover, the depth model determines a depth value for an object within the scene based on comparing the first measurement with the second measurement. To that end, the depth model may control movement of a vehicle based on the depth value for the object.

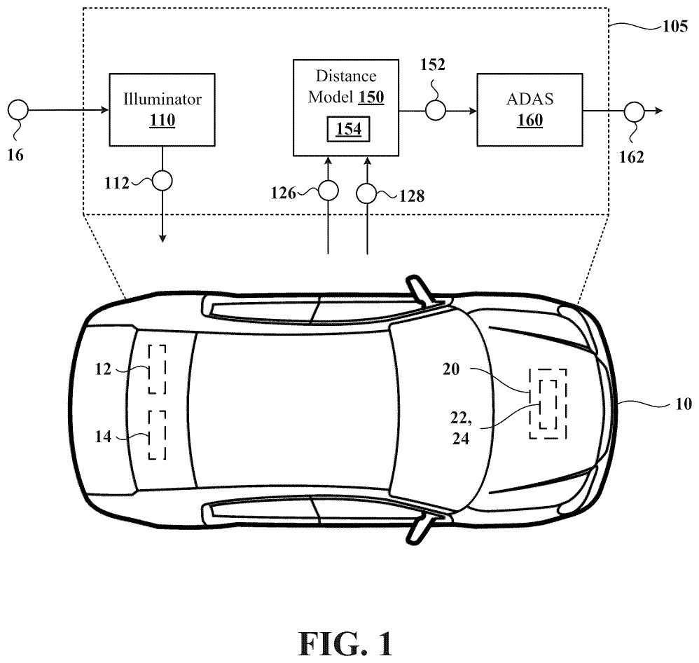

Referring now to the drawings, and specifically to FIGS. 1-3, a vehicle 10 is depicted as encompassing various integrated components suitable for autonomous or assisted driving operations. The vehicle 10 includes data processing hardware 12 and memory hardware 14. The memory hardware 14 is in communication with the data processing hardware 12. The memory hardware 14 stores executable instructions that, when executed on the data processing hardware 12, cause the data processing hardware 12 to perform operations related to depth sensing and comprehensive scene understanding for a surrounding environment of the vehicle 10.

The vehicle 10 additionally includes one or more light detection and ranging (LiDAR) sensors 20. Each LiDAR sensor 20 may include a light source 22, which is configured to emit light, and an array of a plurality of sensor pixels 24. The LiDAR sensor 20 may be a direct time-of-flight (dToF) sensor or an indirect time-of-flight (iToF) sensor. A direct time-of-flight sensor typically operates by emitting discrete, short pulses of light and then directly measuring the elapsed time taken for the light to travel from the light source 22 to an object 30 within a scene and to return to the plurality of sensor pixels 24. An indirect time-of-flight sensor, in contrast, may emit a continuous, temporally modulated wave of light and subsequently determine distance by measuring the phase shift between the emitted light waveform and the received light waveform. Each LiDAR sensor 20 may have a field of view 26.

LiDAR sensors 20 are susceptible to the presence of spurious light components, which lead to inaccurate or erroneous depth measurements. For instance, internal multipath interference, referred to as blooming, may occur when highly reflective objects in a scene, such as retroreflective overhead road signs, cause extremely bright light to enter the LiDAR sensor 20. The bright light may then bounce between the optical components of the LiDAR sensor 20 and the sensor array before being absorbed. As a result, a portion of the light lands on the sensor pixels 24 that are observing other, more distant parts of the scene. A sensor pixel 24 affected by blooming may therefore record multiple light returns. Namely, a valid return from a corresponding scene point and a spurious return from the blooming artifact. The spurious return may be stronger and arrive earlier than the valid return, potentially confusing a depth estimation algorithm. As such, the system perceives phantom or ghost objects that are not actually present, such as a vertical curtain of points appearing in the middle of a road. For a vehicle 10 relying on this data, such an artifact may be misinterpreted as an obstacle, potentially leading to an unnecessary hard brake.

To mitigate the effects of such spurious light components, the vehicle 10 may include a depth model 105. The depth model 105 operates under the instruction and control of the data processing hardware 12. The depth model 105 may include an illuminator 110. The illuminator 110 is configured to instruct the LiDAR sensor 20, via instructions 112, to project a first illumination pattern 120 toward a scene. The illuminator 110 may receive an input signal 16 from one or more other sensors of the vehicle 10. The input signal 16 may include various types of data indicative of the operating environment and conditions of the vehicle 10, or the status of other systems of the vehicle 10. For example, the input signal 16 could be based on data from an inertial measurement unit (IMU) providing information about vehicle motion, such as acceleration or angular velocity. In another example, the input signal 16 could be based on a signal from a global positioning system (GPS) receiver indicating the location and speed of the vehicle 10. In yet another example, the input signal 16 could be based on data from an external temperature sensor, a rain sensor, a light sensor, or a camera system, providing information about environmental conditions such as ambient light, precipitation, detected objects, or visibility. The illuminator 110 may generate the first illumination pattern 120 based on the input signal 16.

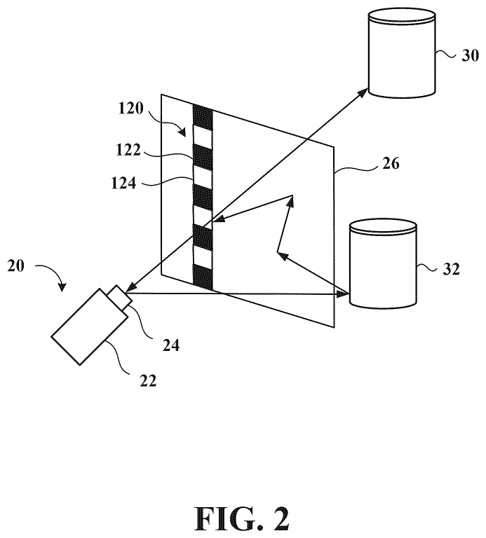

As depicted in FIG. 2, the first illumination pattern 120 is configured to illuminate a first subset of a field of view 122 (e.g., boxes shaded black). Concurrently, the first illumination pattern 120 is configured to refrain from illuminating a second subset of a field of view 124 (e.g., boxes unshaded). An example of such an illumination pattern may include a checkerboard-like pattern, where certain spatially defined regions (e.g., the first subset of the field of view 122) are actively illuminated, while adjacent or complementary spatial regions (e.g., the second subset of the field of view 124) are intentionally left unilluminated or significantly reduced in illumination. The first illumination pattern 120 may be applied uniformly across the entire field of view 26 of the LiDAR sensor 20, or applied on a more granular basis, such as a column-by-column or row-by-row basis, depending on the specific optical design of the LiDAR sensor 20 and the desired scanning methodology. As shown in FIG. 2, the first illumination pattern 120 is applied to a single column within the field of view 26.

Following the projection of the first illumination pattern 120 toward the scene, the plurality of sensor pixels 24 of the LiDAR sensor 20 are configured to capture a first measurement 126. The first measurement 126 corresponds to the light reflected from the scene in response to the projection of the first illumination pattern 120. During the capture of light reflected in response to the first illumination pattern 120, each sensor pixel 24 records the received light. The received light may include not only direct reflections originating from the illuminated portions of the scene but also contributions from spurious light components. Such spurious light components may be caused by phenomena like internal multipath interference (e.g., blooming), external multipath interference, or scattering due to atmospheric conditions (e.g., fog, smoke). The spurious components may propagate from highly reflective objects (e.g., retroreflectors 32) within the scene, or from scattering media, even if those objects or portions of the scene are not directly within the illuminated portion corresponding to a particular sensor pixel 24. The first measurement 126, therefore, represents a superposition of the direct light signal, which carries the true depth information, and any spurious light present during the first illumination phase.

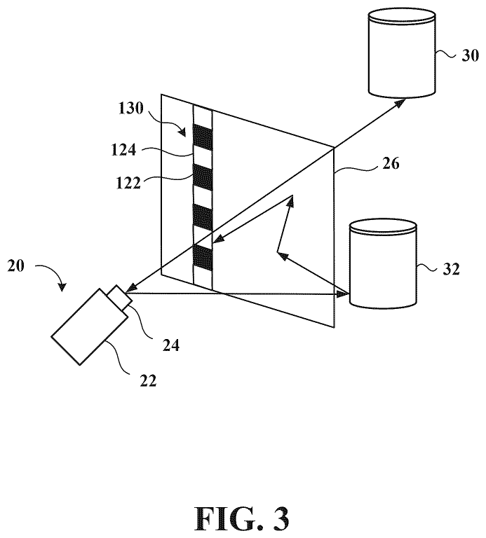

Subsequently, the illuminator 110 instructs the LiDAR sensor 20, via instructions 112, to project a second illumination pattern 130 toward the scene based on the input signal 16. As shown in FIG. 3, the second illumination pattern 130 is configured to illuminate the second subset of the field of view 124. The second subset of the field of view 124 was intentionally not illuminated by the first illumination pattern 120. Simultaneously, the second illumination pattern 130 is configured to refrain from illuminating the first subset of the field of view 122, thereby creating a complementary illumination state relative to the first illumination pattern 120. For instance, if the first illumination pattern 120 includes an illumination of even-indexed elements or regions in a spatial grid across the field of view, the second illumination pattern 130 may include an illumination of odd-indexed elements or regions within the same spatial grid. The complementary projection of illumination patterns is a design feature that facilitates the subsequent separation and isolation of direct light signals from spurious light components.

Following the projection of the second illumination pattern 130, the plurality of sensor pixels 24 of the LiDAR sensor 20 capture a second measurement 128. The second measurement 128 corresponds to the light reflected from the scene in response to the projection of the second illumination pattern 130. During this second capture, each sensor pixel 24 receives light that includes contributions from various spurious light components. The spurious light components, such as those caused by internal multipath interference or blooming, may persist and affect the sensor pixels 24 regardless of the specific illuminated subset. However, for the sensor pixels 24 that are observing areas within the first subset of the field of view 122, the direct light component originating from these specific areas is largely absent, entirely absent, or significantly reduced in the second measurement 128. This is because these areas are not directly illuminated by the second illumination pattern 130. Conversely, sensor pixels 24 observing areas within the second subset of the field of view 124 now receive a direct light component in addition to any spurious light. The captured second measurement 128, therefore, provides another superposition of signals, but with a distinct distribution of direct and spurious light compared to the first measurement 126.

In some implementations, the first illumination pattern 120 and the second illumination pattern 130 each include square wave spatial modulations. Such square wave modulations may involve abrupt and distinct transitions between illuminated regions (e.g., “on” states with high light intensity) and unilluminated regions (e.g., “off” states with minimal or zero light intensity). Thus, the square wave modulations create a clear and distinct on/off pattern across the entire field of view or within a specific scanning column or row. For example, a square wave spatial modulation may manifest as a checkerboard pattern where a defined pixel or a group of pixels is either fully illuminated or fully dark.

In other implementations, the first illumination pattern 120 and the second illumination pattern 130 each include sinusoidal spatial modulations. Sinusoidal spatial modulations, in contrast to square waves, involve a gradual and continuous variation in light intensity across the pattern, resembling a continuous wave (e.g., a sine or cosine wave). The intensity varies smoothly from a minimum to a maximum and back, rather than having sharp, instantaneous transitions. Sinusoidal spatial modulation may offer various advantages in certain optical systems. For example, such modulations may be more robust to bandwidth limitations inherent in optical components or to optical blurring phenomena that occur in real-world implementations due to diffraction, lens aberrations, or atmospheric effects. In some examples, the smooth transitions characteristic of a sinusoidal pattern helps to maintain a consistent signal quality and reduce artifacts, particularly in systems where sharp spatial contrasts are difficult to achieve or maintain with high fidelity. Both square wave and sinusoidal patterns are suitable for generating the complementary illumination states desired for the effective operation of the depth model 105.

In some implementations, the depth model 105 includes a distance model 150. The distance model 150 is configured to determine a depth value 152 for one or more objects 30 within the scene. The distance model 150 determines the depth value 152 based on comparing the first measurement 126 with the second measurement 128. In some implementations, the distance model 150 compares the first measurement 126 with the second measurement 128 by determining a difference 154 between the first measurement 126 and the second measurement 128. In some examples, the depth model 105 performs the difference calculation on a per-pixel basis. The objective of this difference operation is to isolate a direct light component from a spurious light component. For example, the spurious light component may originate from internal multipath interference (e.g., blooming), external multipath interference (e.g., light bouncing between multiple objects in the scene), or scattered light due to adverse atmospheric conditions such as fog, smoke, or heavy precipitation. When employing the first illumination pattern 120 and the second illumination pattern 130, each captured first measurement 126 and second measurement 128 for a given sensor pixel 24 may include a direct light component (e.g., if the corresponding pixel's scene point was directly illuminated by that pattern) and approximately half of the total spurious light component. This approximation holds because the spurious light often originates from a broader area and the magnitude of the spurious light is generally proportional to the total light emitted into the scene.

By taking the difference between the first measurement 126 and the second measurement 128 on a per-pixel basis, the common spurious light component, which is roughly consistent across both captures for that sensor pixel, may be substantially reduced or effectively eliminated. In a specific implementation, the distance model 150 may determine the difference 154 by subtracting the second measurement 128 from the first measurement 126, or vice versa, to derive a resultant signal that primarily represents the direct light reflection from the scene. This process allows for a more accurate and reliable determination of the depth value 152, as the influence of undesired spurious reflections or scattered light is significantly mitigated.

The depth model 105 may include an advanced driver assistance system (ADAS) 160. The ADAS 160 is configured to control movement of the vehicle 10 based on the determined depth value 152 for the object 30. In particular, the ADAS 160 may generate one or more control signals 162 that control the movement of the vehicle based on the depth value 152. The accurate depth values 152, which are substantially free from the corruption of spurious light components, provide a more reliable and robust understanding of the surrounding environment of the vehicle 10. The enhanced environmental perception may lead to improved decision-making by the ADAS 160. For instance, the system may enable more precise and timely braking maneuvers, more accurate acceleration control, or more refined steering adjustments. The reduction in the influence of spurious data also lowers the likelihood of false positive obstacle detection, which could otherwise lead to unnecessary or erroneous vehicle responses. The reliable depth information obtained through this method contributes significantly to increased safety and overall performance of the autonomous or assisted driving functions of the vehicle 10.

In some implementations, the depth model 105 may perform a calibration of the LiDAR sensor 20. The calibration is specifically designed to account for any imperfect spatial modulation of the first illumination pattern 120 and/or the second illumination pattern 130. As discussed, practical optical systems may not perfectly reproduce ideal square wave or sinusoidal patterns. To that end, the calibration may involve a one-time routine to measure the actual spatial intensity profile of the projected patterns at each pixel and subsequently derive correction factors (e.g., alpha and beta values). The depth model 105 may apply the correction factors during the comparison and subtraction process to ensure that the spurious light component is removed as completely and accurately as possible, even with real-world imperfections in the illumination patterns.

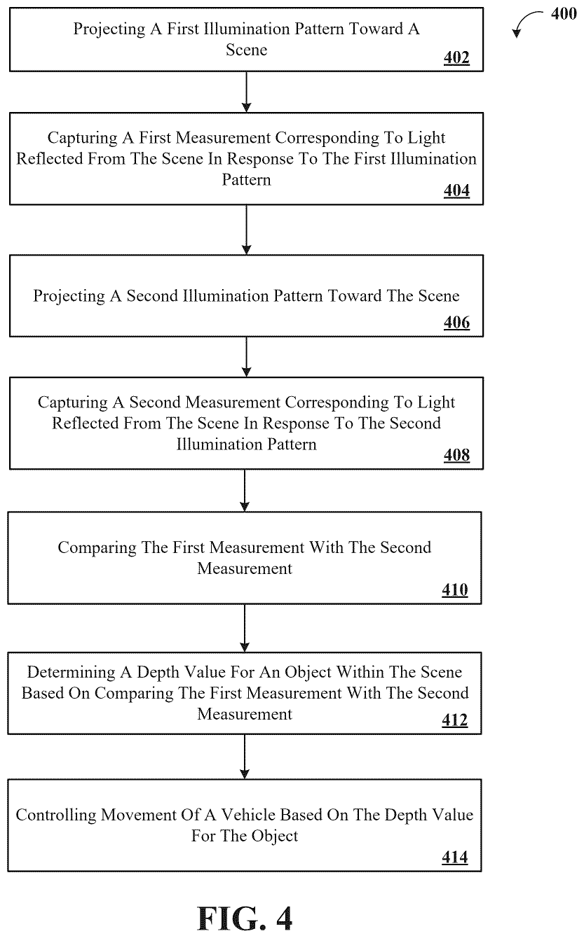

FIG. 4 illustrates a computer-implemented method 400 of performing dappled illumination using depth sensors (e.g., LiDAR sensors 20). The data processing hardware 12 may perform the operations of the method 400. At operation 402, the method 400 includes projecting, from the LiDAR sensor 20, a first illumination pattern 120 toward a scene. The first illumination pattern 120 illuminates a first subset of a field of view 122 and refrains from illuminating a second subset of the field of view 124. At operation 404, the method 400 includes capturing, by a plurality of sensor pixels 24 of the LiDAR sensor, a first measurement 126 corresponding to light reflected from the scene in response to the first illumination pattern 120. At operation 406, the method 400 includes projecting, from the LiDAR sensor 20, a second illumination pattern 130 toward the scene. The second illumination pattern 130 illuminates the second subset of the field of view 124 and refrains from illuminating the first subset of the field of view 122. At operation 408, the method 400 includes capturing, by the plurality of sensor pixels 24 of the LiDAR sensor 20, a second measurement 128 corresponding to light reflected from the scene in response to the second illumination pattern 130. At operation 410, the method 400 includes comparing the first measurement 126 with the second measurement 128. At operation 412, the method 400 includes determining a depth value 152 for an object 30 within the scene based on comparing the first measurement with the second measurement. At operation 414, the method 400 includes controlling movement of the vehicle 10 based on the depth value 152 for the object 30.

As such, the depth model 105 provides robust depth sensing, particularly within LiDAR and other Time-of-Flight systems, by strategically addressing the pervasive issue of spurious light components such as blooming, internal multipath, external multipath, and environmental scattering (e.g., fog or smoke). Unlike conventional systems that attempt to correct for these artifacts computationally after data acquisition, this approach proactively mitigates them at the hardware level during the data capture process. By employing a complementary, dappled illumination scheme and performing a direct, per-pixel differential measurement, the depth model 105 effectively isolates the true direct light signal from extraneous noise.

Notably, the depth model 105 employs the sequential projection of two distinct illumination patterns. The first illumination pattern 120 illuminates the first subset of the field of view 122 while leaving the second subset of the field of view 124 unilluminated, and a corresponding first measurement 126 is captured. Thereafter, a second illumination pattern 130 is projected (e.g., which is complementary to the first illumination pattern 120), illuminating the previously unilluminated subset and vice versa, and a second measurement 128 is captured. The depth model 105 compares these two measurements, for example, by subtracting them on a per-pixel basis. This operation leverages the characteristic that spurious light components, being largely a function of the total emitted light and system optics, manifest consistently (and are approximately halved) across both complementary illumination phases. Consequently, the subtraction cancels out these undesirable components, yielding a clean signal that represents only the direct light reflection from the scene. This uncorrupted direct signal is then used to accurately determine depth values for objects, which significantly enhances the reliability of vehicle control systems.

Furthermore, the depth model 105 is adaptable to various illumination profiles, including checkerboard patterns and sinusoidal spatial modulations, the latter offering increased robustness to optical imperfections. The depth model 105 also accounts for real-world non-idealities through a calibration routine that measures imperfect spatial modulation and applies correction factors during the differential process. This hardware-centric, differential measurement strategy offers a superior solution to the challenges posed by spurious light, providing more accurate and dependable depth information for critical applications such as autonomous vehicle navigation, where false positives or underestimated depths may have severe consequences. The ability to mitigate these complex light propagation issues directly at the sensing stage represents a significant step forward in achieving high-fidelity environmental perception.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executed on data processing hardware that causes the data processing hardware to perform operations comprising:
projecting, from a light detection and ranging (LiDAR) sensor, a first illumination pattern toward a scene, wherein the first illumination pattern illuminates a first subset of a field of view and refrains from illuminating a second subset of the field of view;
capturing, by a plurality of sensor pixels of the LiDAR sensor, a first measurement corresponding to light reflected from the scene in response to the first illumination pattern;
projecting, from the LiDAR sensor, a second illumination pattern toward the scene, wherein the second illumination pattern illuminates the second subset of the field of view and refrains from illuminating the first subset of the field of view;
capturing, by the plurality of sensor pixels of the LiDAR sensor, a second measurement corresponding to light reflected from the scene in response to the second illumination pattern; and
comparing the first measurement with the second measurement;
based on comparing the first measurement with the second measurement, determining a depth value for an object within the scene; and
controlling movement of a vehicle based on the depth value for the object.

2. The method of claim 1, wherein comparing the first measurement with the second measurement comprises determining a difference between the first measurement and the second measurement on a per-pixel basis to isolate a direct light component from a spurious light component.

3. The method of claim 2, wherein determining the difference between the first measurement and the second measurement comprises subtracting the second measurement from the first measurement.

4. The method of claim 3, wherein:
the first illumination pattern comprises a first checkerboard pattern of illumination; and
the second illumination pattern comprises a second checkerboard pattern of illumination different than the first checkerboard pattern.

5. The method of claim 4, wherein:
the first checkerboard pattern illuminates a first set of pixels;
the second checkerboard pattern illuminates a second set of pixels;
the second set of pixels are not illuminated by the first checkerboard pattern; and
the first set of pixels are not illuminated by the second checkerboard pattern.

6. The method of claim 1, wherein the operations further comprise performing a calibration of the LiDAR sensor to account for imperfect spatial modulation of the first illumination pattern or the second illumination pattern.

7. The method of claim 1, wherein the first illumination pattern and the second illumination pattern each comprise square wave spatial modulations.

8. The method of claim 1, wherein the first illumination pattern and the second illumination pattern each comprise sinusoidal spatial modulations.

9. The method of claim 1, wherein the LiDAR sensor comprises a direct time-of-flight sensor.

10. The method of claim 1, wherein the LiDAR sensor comprises an indirect time-of-flight sensor.

11. A vehicle comprising:
a light detection and ranging (LiDAR) sensor;
data processing hardware; and
memory hardware in communication with the data processing hardware, the memory hardware storing instructions that when executed on the data processing hardware cause the data processing hardware to perform operations comprising:
projecting, from the LiDAR sensor, a first illumination pattern toward a scene, wherein the first illumination pattern illuminates a first subset of a field of view and refrains from illuminating a second subset of the field of view;
capturing, by a plurality of sensor pixels of the LiDAR sensor, a first measurement corresponding to light reflected from the scene in response to the first illumination pattern;
projecting, from the LiDAR sensor, a second illumination pattern toward the scene, wherein the second illumination pattern illuminates the second subset of the field of view and refrains from illuminating the first subset of the field of view;
capturing, by the plurality of sensor pixels of the LiDAR sensor, a second measurement corresponding to light reflected from the scene in response to the second illumination pattern; and
comparing the first measurement with the second measurement;
based on comparing the first measurement with the second measurement, determining a depth value for an object within the scene; and
controlling movement of the vehicle based on the depth value for the object.

12. The vehicle of claim 11, wherein comparing the first measurement with the second measurement comprises determining a difference between the first measurement and the second measurement on a per-pixel basis to isolate a direct light component from a spurious light component.

13. The vehicle of claim 12, wherein determining the difference between the first measurement and the second measurement comprises subtracting the second measurement from the first measurement.

14. The vehicle of claim 13, wherein:
the first illumination pattern comprises a first checkerboard pattern of illumination; and
the second illumination pattern comprises a second checkerboard pattern of illumination different than the first checkerboard pattern.

15. The vehicle of claim 14, wherein:
the first checkerboard pattern illuminates a first set of pixels;
the second checkerboard pattern illuminates a second set of pixels;
the second set of pixels are not illuminated by the first checkerboard pattern; and
the first set of pixels are not illuminated by the second checkerboard pattern.

16. The vehicle of claim 11, wherein the operations further comprise performing a calibration of the LiDAR sensor to account for imperfect spatial modulation of the first illumination pattern or the second illumination pattern.

17. The vehicle of claim 11, wherein the first illumination pattern and the second illumination pattern each comprise square wave spatial modulations.

18. The vehicle of claim 11, wherein the first illumination pattern and the second illumination pattern each comprise sinusoidal spatial modulations.

19. The vehicle of claim 11, wherein the LiDAR sensor comprises a direct time-of-flight sensor.

20. A computer program product encoded on a non-transitory computer readable storage medium comprising instructions that when executed by a data processing apparatus cause the data processing apparatus to perform operations comprising:
projecting, from a light detection and ranging (LiDAR) sensor, a first illumination pattern toward a scene, wherein the first illumination pattern illuminates a first subset of a field of view and refrains from illuminating a second subset of the field of view;
capturing, by a plurality of sensor pixels of the LiDAR sensor, a first measurement corresponding to light reflected from the scene in response to the first illumination pattern;
projecting, from the LiDAR sensor, a second illumination pattern toward the scene, wherein the second illumination pattern illuminates the second subset of the field of view and refrains from illuminating the first subset of the field of view;
capturing, by the plurality of sensor pixels of the LiDAR sensor, a second measurement corresponding to light reflected from the scene in response to the second illumination pattern; and
comparing the first measurement with the second measurement;
based on comparing the first measurement with the second measurement, determining a depth value for an object within the scene; and
controlling movement of a vehicle based on the depth value for the object.
